(19) United States
(12) Patent Application Publication
(10) Pub. No.: US 2008/0220977 A1
(43) Pub. Date: Sep. 11, 2008

(54) Computational strategy for discovering druggable gene networks from genome-wide RNA expression profiles

(75) Inventors: Seiya Imoto, Tokyo (JP); Satoru Miyano, Tokyo (JP); Christopher Savoie, Fukuoka (JP); Cristin Print, Auckland (NZ); David Stephen Charnock-Jones, Cambridge (GB)

Correspondence Address: WILSON SONSINI GOODRICH & ROSATI, 650 PAGE MILL ROAD, PALO ALTO, CA, 94304-1050, US

(73) Assignee: GNI Ltd., Tokyo (JP)

(21) Appl. No.: 11/546,820

(22) Filed: Oct. 11, 2006

Related U.S. Application Data
(60) Provisional application No. 60/725,701, filed on Oct. 12, 2005.

(51) Int. Cl. C40B 20/00; C40B 60/14; C40B 50/02

(52) U.S. Cl. 506/2; 506/24; 506/40

(57) ABSTRACT

Embodiments of this invention include application of new inferential methods to analysis of complex biological information, including gene networks. New methods include modifications of Bayesian inferential methods and application of those methods to determining cause and effect relationships between expressed genes, and in some embodiments, for determining upstream effectors of regulated genes. Additional modifications of Bayesian methods include use of time course data and use of gene disruption data to infer causal relationships between expressed genes. Other embodiments include the use of bootstrapping methods and determination of edge effects to more accurately provide network information between expressed genes. Information about gene networks can be stored in a memory device and can be transmitted to an output device, or can be transmitted to remote location.

### CROSS-REFERENCE TO RELATED APPLICATIONS

This application claims the benefit of Provisional Patent Application No. 60/725,701, filed Oct. 12, 2005, which is incorporated by reference herein in its entirety.

### BACKGROUND OF THE INVENTION

A. Field of the Invention

The present invention relates to systems and methods for constructing gene network models and determining relationships between genes.

B. Description of the Related Art

One of the most important aspects of current research and development in the life sciences, medicine, drug discovery and development and pharmaceutical industries is the need to develop methods and devices for interpreting large amounts of raw data and drawing conclusions based on such data. Bioinformatics has contributed substantially to the understanding of systems biology and promises to produce even greater understanding of the complex relationships between components of living systems. In particular, with the advent of new methods for rapidly detecting expressed genes and for quantifying expression of genes, bioinformatics can be used to predict potential therapeutic targets even without knowing with certainty, the exact roles a particular gene(s) may play in the biology of an organism.

Simulation of genetic systems is a central topic of systems biology. Because simulations can be based on biological knowledge, a network estimation method can support biological simulation by predicting or inferring previously unknown relationships.

In particular, development of microarray technology has permitted studies of expression of a large number of genes from a variety of organisms. A large amount of raw data can be obtained from a number of genes from an organism, and gene expression can be studied by intervention either by mutation, disease or drugs. Finding that a particular gene's expression is increased in a particular disease or in response to a particular intervention may lead one to may then be modified to increase potency, stability, or other properties, and the modified compounds retested in the assay. This approach returns little or no information on the mechanisms of action or cellular pathways affected by the candidates.

A second approach to drug discovery involves testing numerous compounds for a specific effect on a known molecular target, typically a cloned gene sequence or an isolated enzyme or protein. For example, high-throughput assays can be developed in which numerous compounds can be tested for the ability to change the level of transcription from a specific promoter or the binding of identified proteins. Although the use of high-throughput screens is a powerful methodology for identifying drug candidates, again it provides little or no information about the effects of a compound at the cellular or organismal level, in particular information concerning the actual cellular pathways affected.

In fact, analysis of the pathway of efficacy and toxicity of candidate drugs can consume a significant fraction of the drug development process (see, e.g., Oliff et al., 1997, “Molecular Targets for Drug Development,” in DeVita et al. Cancer: Principles & Practice of Oncology 5th Ed. 1997 Lippincott-Raven Publishers, Philadelphia). Therefore, methods of improving this analysis are of considerable current value.

In the past, it has been possible to glean some information to some extent about the pathways and mechanisms occurring inside a biological system of interest (including pathways of drug action) by simply observing the system's response to known inputs. The response observed has typically been gene expressions (i.e., mRNA abundances) and/or protein abundances. The inputs are experimental perturbations including genetic mutations (such as genetic deletions), drug treatments, and changes in environmental growth conditions.

However, it has been a usually hopeless task to try to infer the details of the system simply from the observed input-output relationships. Even if a pathway hypothesis is available, it has not been easy to determine if differential experiments provides adequate or efficient tests or confirmation of the pathway hypothesis. And even with such experiments, it has not always been known how to interpret their results in view of the pathway hypothesis.

Despite much effort and elaborate measurements, little concrete progress has been made in reconstructing the pathways of biological systems, much less their time-dependent interactions, from simple observations such as protein and mRNA concentrations (McAdams et al., 1995, Circuit simulation of genetic networks, Science 269:650-656; Reinitz et al., 1995, Mechanism of eve stripe formation, Mechanisms of Development 49:133-158).

One approach to this problem has been bringing modeling tools from other disciplines to bear on this problem. For example, boolean representations and network models familiar to the electrical engineering community have been applied to biological systems (Mikulecky, 1990, Modeling intestinal absorption and other nutrition-related processes using PSPICE and STELLA, J. of Ped. Gastroenterology and Nutrition 11:7-20; McAdams et al., 1995, Circuit simulation of genetic networks, Science 269:650-656). One application has been to the control of gene transcription during development, particularly during sequential organism development (Yuh et al., 1998, Genomic Cis-regulatory logic: Experimental and computational analysis of a sea urchin gene, Science 279:1896-1902).

The difficulties noted in developing and testing models of biological pathways in organisms has hindered effective use of the great advances recently made in biological measurement techniques. While traditional bioinformatic techniques have enabled the simultaneous study of thousands of molecular signals and their patterns of co-regulation, they suffer from the inability to reveal causal relationships among molecular signals within cells. This is a significant setback since the combination of the cause and effect relationships between all the signals operating in a cell, rather than the isolated actions of individual signals, is typically what drives and regulates processes.

Thus, much effort is being expended to develop methods for determining cause and effect relationships between genes, which genes are central to a biological phenomenon, and which genes' expression(s) are peripheral to the biological process under study. Although such peripheral gene's expression may be useful as a marker of a biological or pathophysiological condition, if such a gene is not central to physiological or pathophysiological conditions, developing drugs based on such genes may not be worth the effort. In contrast, for genes identified to be central to a process, development of drugs or other interventions may be crucial to developing treatments for conditions associated with altered expression of genes.

Increasingly, mathematical methods are being employed to determine relationships between expressed genes. However, accurately deriving a gene regulatory network from gene expression data can be difficult. Several mathematical methods have been used to infer gene regulatory networks such as differential equation models (Chen et al. 1999; de Hoon et al. 2003), state space models (Rangel et al. 2004), Boolean network models (Akutsu et al. 1998; Shmulevich et al. 2002) and Bayesian network models (Friedman et al. 2000; Imoto et al. 2002). See also U.S. patent application Ser. No. 10/259,723, filed Sep. 26, 2002, U.S. patent application Ser. No. 10/722,033, filed Nov. 25, 2003, and U.S. patent application Ser. No. 10/716,330, filed Nov. 18, 2003, which are incorporated herein fully by reference).

### SUMMARY OF THE INVENTION

In certain embodiments, this invention includes the use of time course expression data in a Bayesian network model with nonparametric regression. The Bayesian network model estimated from time course data by dynamic Bayesian network model can be combined with gene knockdown expression data, and regulatory relations estimated from knock down microarrays to construct an accurate gene network that reflects the affect of a chemical compound on the system. The invention can be applied to identify a gene network affected by an agent, identify a target gene in a system containing a gene network, or to provide a service that receives raw data from a party and identify target genes for the party based on a gene network model constructed according to the present invention.

### BRIEF DESCRIPTION OF THE DRAWINGS

FIG. 1 is a schematic showing the various steps in the gene network construction method of the present invention.

FIG. 2 is a computer generated visualization of the node downstream of PPAR-α in a gene network constructed according to the method of the invention.

FIG. 3 shows a sub-network related to PPAR-α.

FIG. 4 shows a time course of transcriptome change during EC apoptosis. Scatter-plots show each transcript represented by a dot, with abundance at time 0 shown on each x-axis and abundance at other time points shown on the y-axes; FIG. 4A: 1.5 hours, FIG. 4B: 6 hours, FIG. 4C: 9 hours and FIG. 4D: 24 hours SFD. Those transcripts that are not regulated remain approximately on the diagonal. Transcripts that appeared to be up-regulated when cultures were exposed to SFD conditions for 24 hours were compared to healthy cultures at time 0 are highlighted in white. The gradual up-regulation of these transcripts over time can be seen.

FIG. 5 illustrates an application of k-means clustering, which revealed 8 groups of transcripts (from a short-list of 685 highly regulated transcripts) that followed distinct temporal patterns of regulation.

FIG. 6 shows the kinetics of SFD-dependant regulation of transcript abundance. Values represent median fold change (relative to 0 hr) of normalised transcript abundance of the triplicate time course data. Negative values represent down regulation. Positive values represent up-regulation.

FIG. 7 shows an example of a dynamic timecourse gene regulatory network.

FIG. 7A shows a graph representing a dynamic Bayesian gene network generated from the median of triplicated apoptosis timecourse data. Dots represents transcripts (“nodes”) and lines between the dots represent potential cause and effect interactions (“edges”).

FIG. 7B shows a graph showing apoptosis timecourse gene array transcript abundance data for a parent RNA transcript in the network (CDKN1C, black) and its putative children (C1QTNF5, green; AKR1C3, blue; MLF1, orange and SUV39H1, red).

FIG. 8 shows an example of a dynamic timecourse gene regulatory network modified by inclusion of prior information from siRNA disruptant experiments.

FIG. 8A is a scatterplot comparing transcript abundance in un-transfected HUVEC (x-axis) with transcript abundance in mock HUVEC transfected with control siRNAs directed against luciferase (y-axis)—little regulation of transcript abundance appears to have occurred.

FIG. 8B is a scatterplot comparing transcript abundance in HUVEC transfected with siRNAs directed against luciferase (x-axis) with transcript abundance in HUVEC transfected with siRNAs directed against NFκB p105 (y-axis)—NFκB p105 (circled) was down-regulated >4-fold and a large number of additional transcripts were also regulated in abundance.

FIG. 8C shows a graph representing an apoptosis timecourse gene network generated that had been modified by incorporating, as a Bayesian prior, gene array data from 8 siRNA disruptant experiments, similar to those shown in FIG. 8A-B.

FIG. 9 is a block diagram illustrating a computer system suitable as an operating environment for an implementation of the invention.

FIG. 10 is a flow chart showing the method of the invention for constructing a gene network model using Bayesian network and dynamic Bayesian network.

### DETAILED DESCRIPTION OF THE INVENTION

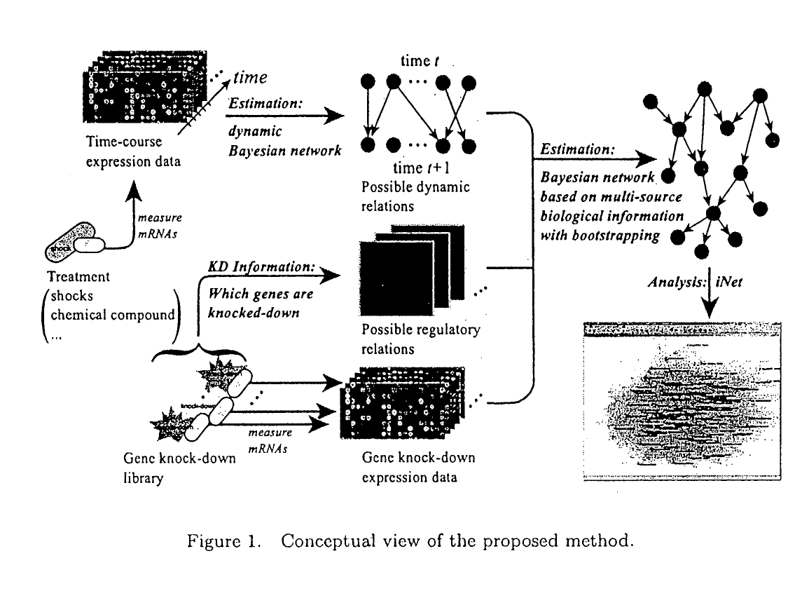

The present invention utilizes computational strategies for combining different types of biological information to construct an accurate gene network. In some embodiments of the invention, the method is used to discover druggable gene networks, i.e. those that are most strongly affected by a chemical compound. To illustrate the method, we use two types of microarray data: One is gene expression data obtained by measuring transcript abundance responses over time following treatment with the chemical compound. The other is gene knock-down expression data, where one gene is knocked-down for each microarray. FIG. 1 provides a conceptual view of our strategy.

First, we estimate dynamic relationships denoted by G_{T} between genes based on time-course data by using dynamic Bayesian networks. Second, in gene knock-down expression data, since we know the information of knocked-down genes, possible regulatory relationships between knocked-down gene and its regulatees can be derived. We denote this information by R. Finally, the gene network G_{K} is estimated by gene knock-down data denoted by X_{K} together with G_{T} and R by using Bayesian networks based on multi-source biological information. The key idea for estimating a gene network based on multi-source biological information is to use G_{T} and R as the Bayesian prior probability of G_{K}. In the present invention, we extend the prior probability of graph in order to use prior information represented as continuous values. After estimating a gene network, we have also developed a gene network analysis tool called iNET that is an extended version of G.NET for extracting biologically plausible information from the estimated gene network. The iNet tool provides a computational environment for various path searches among genes with annotated gene network visualization.

The method of the present invention can estimate druggable gene networks as directed graphs, that are sub-networks of the tissue-specific network. In this method, the edge direction is very important information and selection of compound-related genes is necessary. Our method is also capable of using various kinds of biological data, which further enhances the accuracy of the estimated network, and enables not merely the identification of affected genes, but also the elucidation of their dependency as the network.

### Methods for Constructing Gene Networks

In one embodiment of the present invention, we use Bayesian networks and dynamic Bayesian networks for estimating gene networks from gene knock-down and time-course microarray data, respectively. In this section, we briefly describe these two network models and then elucidate how we combine multi-source biological information to estimate more accurate gene networks.

Suppose that we have the observational data X the set of p random variables X={X₁, . . . Xₚ) and that the dependency among p random variables, shown as a directed graph G, is unknown and we want to estimate it from X. In gene network estimation based on microarray data, a gene is regarded as a random variable representing the abundance of a specific RNA species, and X is the microarray data. From a Bayes approach, the optimal graph is selected by maximizing the posterior probability of the graph conditional on the observed data. By the Bayes' theorem, the posterior probability of the graph can be represented as

$$p ( G \vert X ) = \frac{p ( G ) p ( X \vert G )}{p ( X )} ∝ p ( G ) p ( X \vert G ) ,$$

where p(G) is the prior probability of the graph, p(X|G) is the likelihood of the data X conditional on G and p(X)) is the normalizing constant and does not depend on the selection of G. Therefore, we need to set p(G) and compute p(X|G) for the graph selection based on p(G|X).

The prior probability of the graph p(G) enables us to use biological data other than microarray data to estimate gene networks and the likelihood p(X|G) can be computed by Bayesian networks and dynamic Bayesian networks from gene knock-down and time-course microarray data, respectively. As those of skill in the art will recognize, the present invention can be broadly applied to biological data other than gene knock-down and time-course microarray data. We elucidate how we construct p(G|X) in the following sections.

### Bayesian Networks

Bayesian networks are a graphical model that represents the causal relationship in random variables. In the Bayesian networks, we use a directed acyclic graph encoding Markov relationship between connected nodes. Suppose that we have a set of random variables X={X₁, . . . , Xₚ) and that there is a causal relationship in X by representing a directed acyclic graph G_{K}. Bayesian networks then enable us to compute the joint probability by the product of conditional probabilities

$$Pr ( χ ) = {\prod }_{j = 1}^{p} Pr ( {X}_{j} \vert P {a}_{j} ) , \qquad ( 1 )$$

where Paⱼ is the set of random variables corresponding to the direct parents of Xⱼ in G_{K}. In gene network estimation, we regard a gene as a random variable representing the abundance of a specific RNA species, shown as a node in a graph, and the interaction between genes is represented by the direct edge between nodes.

Let X_{K} be an N×p gene knock-down data matrix whose (i, j)-th element xⱼ|Dᵢ corresponds to the expression data of j-th gene when Dᵢ-th gene is knocked down, where j=1, . . . , p and i=1, . . . , N. Here we assume that i-th knock-down microarray is measured by knocking-down Dᵢ-th gene. Since microarray data take continuous variables, we represent the decomposition (1) by using densities

$${f}_{BN} ( {X}_{K} \vert Θ , {G}_{K} ) = {\prod }_{i = 1}^{N} {\prod }_{j = 1}^{p} {f}_{j} ( {x}_{j} \vert {D}_{i} \vert {pa}_{j \vert {D}_{i}} , {θ}_{j} ) ,$$

where Θ=(θ′₁, . . . , θ′ₚ) is a parameter vector, paⱼ|Dᵢ is the expression value vector of Paⱼ measured by i-th knock-down microarray. Hence, the construction of the graph G_{K} is equivalent to model the conditional probabilities fⱼ (j=1, . . . , p), that is essentially the same as the regression problem. For constructing fⱼ(xj|Dᵢ|paⱼ|Dᵢ, θⱼ), we assume the nonparametric regression model with B-splines of the form

$${x}_{j \vert {D}_{i}} = {\sum }_{k = 1}^{\vert P {a}_{j} \vert} {m}_{jk} ( {pa}_{j \vert {D}_{i}}^{( k )} ) + {ɛ}_{j \vert {D}_{i}} ,$$

where pa_{j|Di}^{(k)} is the k-th element of pa_{j|Di}, ε_{j|Di}˜i.i.d.N(0, σ²) for i=1, . . . N, and mⱼₖ (k=1, . . . , |Paⱼ|) are smooth functions constructed by B-splines as mⱼₖ(x)=Σₘ₌₁^{M}^{ⱼₖ}γHere γₘ^{(jk)} y m
and b^{(jk)}ₘ(x) (m=1, . . . , Mⱼₖ) are parameters and B-splines, respectively.

The likelihood p(X_{K}|G_{K}) is then obtained by

p(X_{K}|G_{K})=∫f_{BN}(X_{K}|Θ,G_{K})p(Θ|λ,G_{K})dΘ, (2)

where p(Θ|λ, G_{K}) is the prior distribution on the parameter Θ specified by the hyperparameter λ. The high-dimensional integral can be asymptotically approximated with an analytical form by the Laplace approximation and Imoto et al. defined a graph selection criterion, named BNRC, of the form

$$BNRC ( {G}_{K} ) = - 2 log \{ p ( {G}_{K} ) \} - r log ( 2 π / N ) + log \vert {J}_{λ} ( \hat{Θ} \vert {X}_{K} ) \vert - 2 {Nl}_{λ} ( \hat{Θ} \vert {X}_{K} ) , \\ {l}_{λ} ( Θ \vert {X}_{K} ) = \frac{1}{N} \{ log {f}_{BN} ( {X}_{K} \vert Θ , {G}_{K} ) + log p ( Θ \vert λ , {G}_{K} ) \} , \\ {J}_{λ} ( Θ \vert {X}_{K} ) = - \frac{{\partial }^{2}}{\partial Θ \partial {Θ}^{l}} {l}_{λ} ( Θ \vert {X}_{K} ) ,$$

where
r is the dimension of Θ, and Θ is the mode of l_{λ}(Θ|X_{K}). The network structure is learned so that BNRC (G_{K}) decreases by the greedy hill-climbing algorithm. We should note that the solution obtained by the greedy hill-climbing algorithm cannot be guaranteed as the optimal. To find better solution, we repeat the greedy algorithm and choose the best one as G_{K}. It happens quite often that the likelihood p(X_{K}|G_{K}) gives almost the same values for several network structures, construction an effective p(G_{K}) based on various kinds of biological information is a key technique. We elucidate how we construct p(G_{K}) in the section entitled “Combining Multi-Source Biological Information for Gene Network Estimation.”

### Dynamic Bayesian Networks

Dynamic Bayesian networks represent the dependency in random variables based on time-course data. Let X(t)={X₁(t), . . . , Xₚ(t)} be the set of p random variables at time t (t=1, 7). In the dynamic Bayesian networks, a directed graph that contains p nodes is rewritten as a complete bipartite graph that allows direct edges from X(t) to X(t+1), where t=1, . . . , T−1. The directed graph G_{T} of the causal relationship among p random variables is then constructed by estimating the bipartite graph defined above. Under G_{T} structure, we then have the decomposition

$$Pr ( χ ( 1 ) , … , χ ( T ) ) = {\prod }_{t = 1}^{T} {\prod }_{j = 1}^{p} Pr ( {X}_{j} ( t ) \vert P {a}_{j} ( t - 1 ) ) , \qquad ( 3 )$$

where Paⱼ(t) is the set of random variables at time t corresponding to the direct parents of Xⱼ in G_{T}.

Let X_{T} be a T×p time-course data matrix whose (t,j)-th element xⱼ(t) corresponds to the expression data of j-th gene at time t, where j=1, . . . , p and t=1, . . . , T. As we described in the Bayesian networks, the decomposition in (3) holds by using densities

$${f}_{DBN} ( {X}_{T} \vert Ξ , {G}_{T} ) = {\prod }_{t = 1}^{T} {\prod }_{j = 1}^{p} {f}_{j} ( {x}_{j} ( t ) \vert p {a}_{j} ( t - 1 ) , {ξ}_{j} , {G}_{T} ) ,$$

where Ξ=(ξ′₁, . . . , ξ′ₚ)′ is a parameter vector, paⱼ(t) is the expression value vector of direct parents of Xⱼ measured at time t. Here we set paⱼ(0)=Ø. We can construct f_{DBN} by using nonparametric regression with B-splines in the same way of the Bayesian networks. Therefore, by replacing f_{BN} by f_{DBN} in (2), Kim et al. proposed a graph selection criterion for dynamic Bayesian networks, named BNRC_{dynamic}, with successful applications.

### Combining Multi-Source Biological Information for Gene Network Estimation

Imoto et al. proposed a general framework for combining biological knowledge with expression data aimed at estimating more accurate gene networks. In Imoto et al., the biological knowledge is represented as the binary values, e.g. known or unknown, and is used for constructing p(G). In reality, there are, however, various confidence in biological knowledge in practice. Bernard and Hartemink constructed p(G) using the binding location data that is a collection of p-values (continuous information). In the method of the present invention, we construct p(G) by using multi-source information including continuous and discrete prior information.

Let Zₖ is the matrix representation of k-th prior information, where (i, j)-th element zᵢ^{j}^{^{(k)}}

represents the information of “gene i→gene j”. For example, (1) If we use a prior network Gₚᵣᵢₒᵣ for Zₖ, Zᵢⁱ^{^{(k)}}
takes 1 if e(i, j)εGₚᵣᵢₒᵣ or 0 if e(i, j)∉Gₚᵣᵢₒᵣ, Here, e(i,j) denotes the direct edge from gene i to gene j. (2) By using the gene knock-down data for Zₖ, Zᵢ^{j}^{^{(k)}} represents the value that indicates how gene j changes by knocking down gene i. We can use the absolute value of the log-ratio of gene j for gene i knock-down data as zᵢ^{j}^{^{(k)}}. Using the adjacent matrix E=(eᵢⱼ)_{1≦i,j≦p} of G, where (eᵢⱼ)=1 for e(i, j)εG or 0 for otherwise, we assume the Bernoulli distribution on eᵢⱼ having probabilistic function

p(εᵢⱼ)=πᵢⱼ^{e}^{ᵢⱼ}(1−πᵢⱼ)^{1-e}^{ᵢⱼ},

where π_{IJ}=Pr(eᵢⱼ=1). For constructing πᵢⱼ, we use the logistic model with linear predictor ηᵢⱼ=Σₖ₌₁^{K}ωₖ(zᵢ^{(k)}ⱼ−cₖ) as πᵢⱼ={1+exp(−ηᵢⱼ)}⁻¹, where ωₖ and cₖ (k=1, . . . , K) are weight and baseline parameters, respectively. We then define a prior probability of the graph based on prior information Zₖ (k=1, . . . , K) by

$$p ( G ) = {\prod }_{i} {\prod }_{j} p ( {e}_{ij} ) .$$

As those of skill in the art will recognize, the method of the present invention can accommodate one or more types of data as prior probability. This prior probability of the graph assumes that edges e(i,j) (i,j=1, . . . , p) are independent of each other. In reality, there are several dependencies among e_{i,j}'s such as p(eᵢⱼ=1)<p(eᵢⱼ=1|eₖᵢ=1), and so on, but we consider adding such information into p(G) to be premature by the quality of such information.

### Exemplary Computer System for Performing the Method

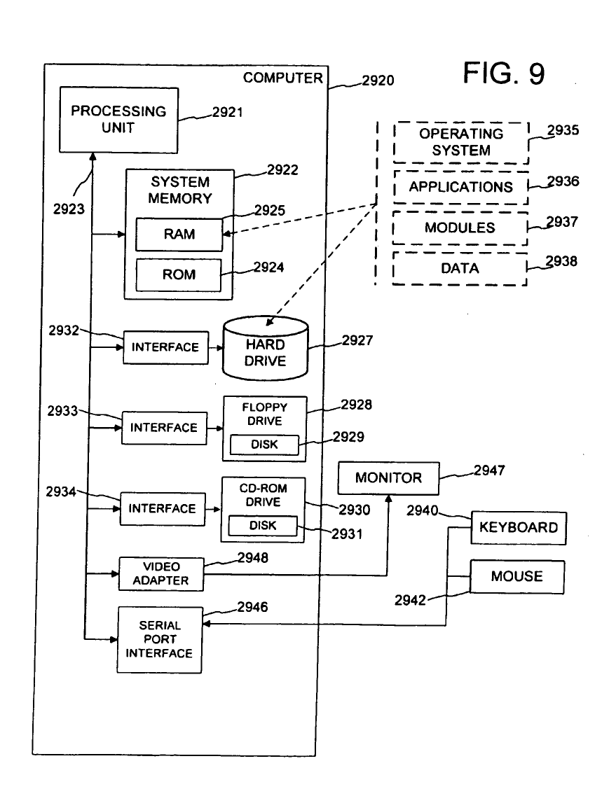

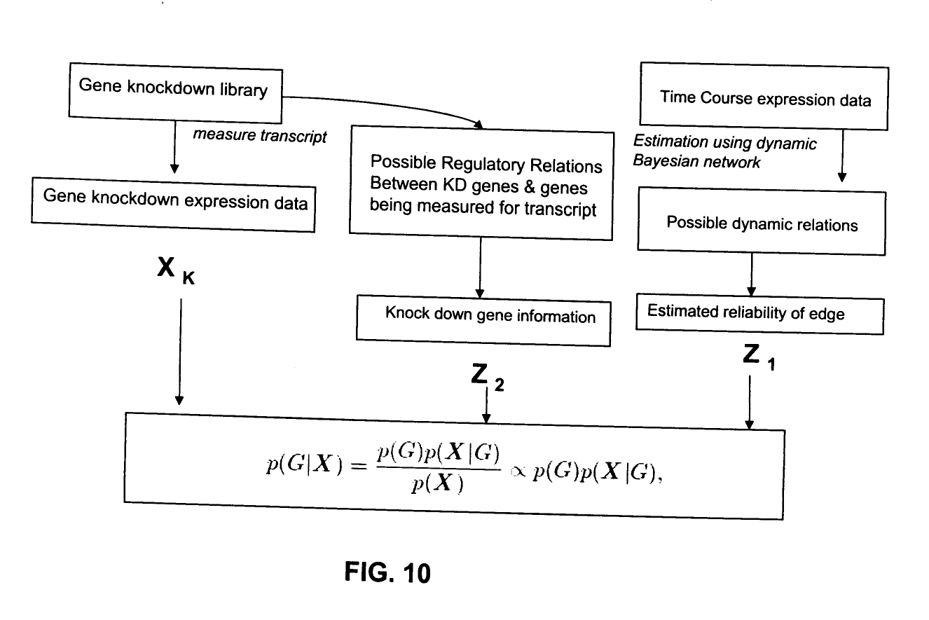

FIG. 9 and the following discussion are intended to provide a brief, general description of a suitable computing environment for computer programs which implement the method described herein. The method for constructing a gene network is implemented in computer-executable instructions organized in program modules. The program modules include the routines, programs, objects, components, and data structures that perform the tasks and implement the data types for implementing the techniques described above.

While FIG. 9 shows a typical configuration of a desktop computer, the invention may be implemented in other computer system configurations, including multiprocessor systems, microprocessor-based or programmable consumer electronics, minicomputers, mainframe computers, and the like. The invention may also be used in distributed computing environments where tasks are performed in parallel by processing devices to enhance performance. For example, tasks related to measuring the effectiveness of a large set of nonlinear models can be performed simultaneously on multiple computers, multiple processors in a single computer, or both. In a distributed computing environment, program modules may be located in both local and remote memory storage devices.

The computer system shown in FIG. 9 is suitable for carrying out the invention and includes a computer 2920, with a processing unit 2921, a system memory 2922, and a system bus 2923 that interconnects various system components, including the system memory to the processing unit 2921. The system bus may comprise any of several types of bus structures including a memory bus or memory controller, a peripheral bus, and a local bus using a bus architecture. The system memory includes read only memory (ROM) 2924 and random access memory (RAM) 2925. A nonvolatile system 2926 (e.g., BIOS) can be stored in ROM 2924 and contains the basic routines for transferring information between elements within the personal computer 2920, such as during start-up. The personal computer 2920 can further include a hard disk drive 2927, a magnetic disk drive 2928, e.g., to read from or write to a removable disk 2929, and an optical disk drive 2930, e.g., for reading a CD-ROM disk 2931 or to read from or write to other optical media. The hard disk drive 2927, magnetic disk drive 2928, and optical disk drive 2930 are connected to the system bus 2923 by a hard disk drive interface 2932, a magnetic disk drive interface 2933, and an optical drive interface 2934, respectively. The drives and their associated computer-readable media provide nonvolatile storage of data, data structures, computer-executable instructions (including program code such as dynamic link libraries and executable files), and the like for the personal computer 2920. Although the description of computer-readable media above refers to a hard disk, a removable magnetic disk, and a CD, it can also include other types of media that are readable by a computer, such as magnetic cassettes, flash memory cards, digital video disks, and the like.

A number of program modules may be stored in the drives and RAM 2925, including an operating system 2935, one or more application programs 2936, other program modules 2937, and program data 2938. A user may enter commands and information into the personal computer 2920 through a keyboard 2940 and pointing device, such as a mouse 2942. Other input devices (not shown) may include a microphone, joystick, game pad, satellite dish, scanner, or the like. These and other input devices are often connected to the processing unit 2921 through a serial port interface 2946 that is coupled to the system bus, but may be connected by other interfaces, such as a parallel port, game port, or a universal serial bus (USB). A monitor 2947 or other type of display device is also connected to the system bus 2923 via an interface, such as a display controller or video adapter 2948. In addition to the monitor, personal computers typically include other peripheral output devices (not shown), such as speakers and printers.

The above computer system is provided merely as an example. The invention can be carried out in a wide variety of other configurations. Further, a wide variety of approaches for collecting and analyzing data related to quantifying gene relatedness is possible. For example, the data can be collected, nonlinear models built, the models' effectiveness measured, and the results presented on different computer systems as appropriate. In addition, various software aspects can be implemented in hardware, and vice versa.

### EXAMPLES

The following examples are provided by way of illustration only and not by way of limitation. Those of skill in the art will readily recognize a variety of non-critical parameters that could be changed or modified to yield essentially similar results.

### Application to Human Endothelial Cells to Generate a Druggable Gene Network

To demonstrate how the present invention operates, we analyzed expression data from human endothelial cells and generated new time-course data that reveal the responses of human endothelial cell transcripts to treatment with the anti-hyperlipidaemia drug fenofibrate. We also generated new data from 270 gene knock-down experiments in human endothelial cells. The fenofibrate-related gene network is estimated based on fenofibrate time-course data and 270 gene knock-down expression data by the method of the invention. The estimated gene network reveals gene regulatory relationships related to PPAR-α, which is known to be activated by fenofibrate. Our computational analysis suggests that this computational strategy based on gene knock-down and drug-dosed time-course microarrays provides a new and improved tool in druggable gene discovery.

### Example 1

### Fenofibrate Time Course Data

We measured the time-responses of human endothelial cell genes to 25 μM fenofibrate. The expression levels of 20,469 probes were measured by CodeLink™ Human Uniset 120K at six time-points (0, 2, 4, 6, 8 and 18 hours). Here time 0 means the start point of this observation and just before exposure to the fenofibrate. In addition, we measured this time-course data as the duplicated data in order to confirm the quality of experiments.

Since our fenofibrate time-course data are duplicated data and contain six time-points, there are 2⁶=64 possible combinations to create a time-course dataset. We should fit the same regression function to a parent-child relationship in the 64 datasets. Under this constraint, we consider fitting nonparametric regression model to the connected data of 64 datasets. That is, if we consider gene i→gene j, we will fit the model xⱼ^{(c)}(t)=mⱼ(xᵢ^{(c)}(t−1))+ε_{f}(t), where xⱼ^{(c)}(t) is the expression data of gene j at time t in the c-th dataset for c=1, . . . , 64. In the Bayesian networks, the reliability of estimated edges can be measured by using the bootstrap method. For time-course data, several modifications of the bootstrap method are proposed such as block resampling, but it is difficult to apply these methods to the small number of data points generated by short time-courses. However, by using above time-course modeling, we can define a method based on the bootstrap as follows: Let D={D(1), . . . , D(64)} be the combinatorial time-course data of all genes. We randomly resample D(c) with replacement and define a bootstrap sample D*={D*(1), . . . , D*(64)}. We then re-estimate a gene network based on D*. We repeat 1000 times bootstrap replications and obtain Ĝ_{T}*, . . . , Ĝ_{T}*¹⁰⁰⁰, where Ĝ_{T}*^{B} is the estimated graph based on the B-th bootstrap sample. The estimated reliability of edge can then be used as the matrix representation of the first prior information Z₁ as zᵢ⁽¹⁾ⱼ=#{B|e(i,j)εĜ_{T}*^{B}, B=1, . . . , 1000}/1000.

### Example 2

### Gene Knock Down Data by siRNA

For constructing exemplary gene networks, we newly created 270 gene knock-down data by using siRNA. We measured 20,469 probes by CodeLink™ Human Uniset 120K for each knock-down microarray after 24 hours of siRNA transfection. The knock-down genes were mainly transcription factors and signaling molecules. Let \tilde{x}_{Di}=(\tilde{x}_{1|Di}, . . . , \tilde{x}_{p|Di})′ be the raw intensity vector of i-th knock-down microarray. For normalizing expression values of each microarray, we computed the median expression value vector ν=(ν₁, . . . , νₚ)′ as the control data, where νⱼ=median i(\tilde{x}_{j|D}_{_{—}}ᵢ). We applied the loess normalization method to the MA transformed data and the normalized intensity xⱼ|_{D}_{_{—}}ᵢ was obtained by applying the inverse transformation to the normalized log(\tilde{x}_{j|D}_{_{—}}ᵢ/νⱼ). We referred to the normalized log(\tilde{x}_{j|D}_{_{—}}ᵢ/νⱼ) as the log-ratio.

In 270 gene knock-down microarray data, we know which gene is knocked-down for each microarray. Thus, when we knocked down gene Dᵢ, genes that significantly change their expression levels can be considered as the direct regulatees of gene Dᵢ. We measured this information by computing corrected log-ratio as follows: The fluctuations of the log-ratios depend on their sum of sample's and control's intensities. From the normalized MA transformed data, we then obtained the conditional variance sⱼ=Var[log(x_{j|D}_{_{—}}ᵢ/νⱼ)|log(x_{j|D}_{_{—}}ᵢ·νⱼ)] and the log-ratios can be corrected zᵢ⁽²⁾ⱼ=log(x_{j|Di}/νⱼ)/sⱼ satisfying Var zᵢ⁽²⁾ⱼ=1.

### Example 3

### Combination of Fenofibrate Time Course Data, Gene Knock Down Data by siRNA, and Knock Down Data Matrix to Generate a Gene Network Model

TABLE 1
Significant GO annotations of selected fenofibrate-relaced
genes from 18 hours microarray.

| | | | p- | # |
|---|---|---|---|---|
| | | GO Function | value | genes |
| [symbol] | GO:0007049 | cell cycle | 1.0E−08 | 35 |
| [symbol] | GO:0000278 | mitotic cell cycle | 3.7E−07 | 19 |
| [symbol] | GO:0000279 | M phase | 5.0E−06 | 17 |
| [symbol] | GO:0006629 | lipid metabolism | 1.3E−05 | 25 |
| [symbol] | GO:0007067 | mitosis | 1.3E−05 | 15 |
| [symbol] | GO:0000087 | M phase of mitotic cell cycle | 1.6E−05 | 15 |
| [symbol] | GO:0000074 | regulation of cell cycle | 2.7E−05 | 22 |
| [symbol] | GO:0044255 | cellular lipid metabolism | 4.4E−05 | 21 |
| [symbol] | GO:0016126 | sterol biosynthesis | 4.3E−04 | 6 |
| [symbol] | GO:0016125 | sterol metabolism | 4.5E−04 | 8 |
| [symbol] | GO:0008203 | cholesterol metabolism | 1.5E−03 | 7 |
| [symbol] | GO:0006695 | cholesterol biosynthesis | 2.4E−03 | 5 |
| [symbol] | GO:0008202 | steroid metabolism | 3.6E−03 | 10 |
| [symbol] | GO:0000375 | RNA splicing, via | 4.1E−03 | 9 |
| | | transesterification reactions | | |
| [symbol] | GO:0000377 | RNA splicing, via | | |
| | | transesterification reactions | | |
| | | with bulged adenosine as | 4.1E−03 | 9 |
| | | nucleophile | | |
| [symbol] | GO:0000398 | nuclear mRNA splicing, | 4.1E−03 | 9 |
| | | via spliceosome | | |
| [symbol] | GO:0006694 | steroid biosynthesis | 6.0E−03 | 7 |
| [symbol] | GO:0016071 | mRNA metabolism | 6.3E−03 | 13 |

For estimating fenofibrate-related gene networks from fenofibrate time-course data and 270 gene knock-down data, we first defined the set of genes that are possibly related to fenofibrate as follows: First, we extracted the set of genes whose variance-corrected log-ratios, |log(x_{j|D}_{_{—}}ᵢ/νⱼ)/sⱼ|, are greater than 1.5 from each time point. We then identified significant clusters of selected genes using GO Term Finder. Table 1 shows the significant clusters of genes at 18 hours. The first column indicates how expression values are changed, i.e. “ [symbol] ” and “ [symbol] ” mean “overexpressed” and “suppressed”, respectively. The GO annotations of clusters with “ [symbol] ” are mainly related to cell cycle, the genes in these clusters are expressed ubiquitously and this is a common biological function. On the other hand, the GO annotations of clusters with “ [symbol] ” are mainly related to lipid metabolism. In biology, it is reported that the fenofibrate acts around 12 hours after exposure. Our first analysis for gene selection suggests that fenofibrate affects genes related to lipid metabolism and this is consistent with biological facts. We also focused on the genes from the 8 hour time-point microarray. Although no cluster with specific function could be found in the selected genes from the 8 hour time-point microarray, there existed some genes related to lipid metabolism. Therefore we used the genes from the 8 and 18 hour time-point microarrays. Finally, we added the 267 knock-down genes (three genes were not spotted on our chips) to the selected genes above, total 1192 genes were defined as possible fenofibrate-related genes and used for the next network analysis.

By converting the estimated dynamic network and knock-down gene information into the matrix representations of the first and second prior information Z₁ and Z₂, respectively, we estimated the gene network Ĝ_{K} based on Z₁, Z₂ and the knock-down data matrix X_{K}. For extracting biological information from the estimated gene network, we first focused on lipid metabolism-related genes, because the clusters related this function were significantly changed at 18 hours microarray. In the estimated gene network, there were 42 lipid metabolism-related genes and PPAR-α (Homo sapiens peroxisome proliferative activated receptor, alpha) is the only transcription factor among them. Actually, PPAR-α is a known target of fenofibrate. Therefore, we next focused on the node downstream of PPAR-α.

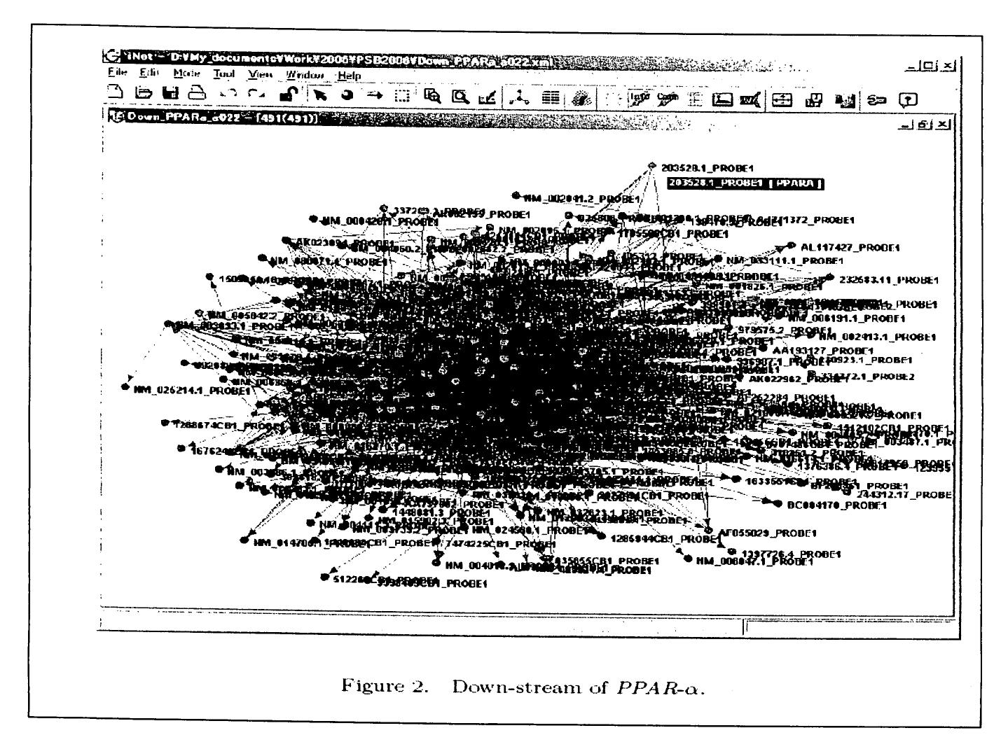

FIG. 2 provides a computer rendering of the node down-stream of PPAR-α (491 genes). Here we consider that genes in the four steps down-stream of PPAR-α are candidate regulatees of PPAR-α. Among the candidate regulatees of PPAR-α, there are 21 lipid metabolism-related genes and 11 molecules previously identified experimentally to be related to PPAR-α. Actually, PPAR-α is known to be activated by fenofibrate, which supports the accuracy of our network.

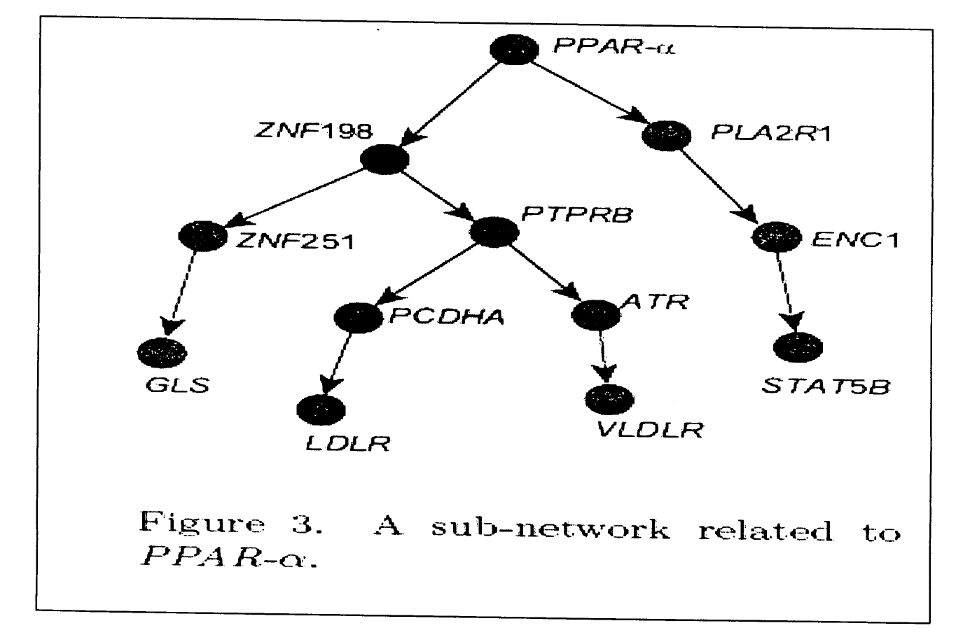

In particular, we show one sub-network having PPAR-α as a root node in FIG. 3. One of the drug efficacies of fenofibrate whose target is PPAR-α is to reduce LDL cholesterol. LDLR and VLDLR mainly contribute the transporting of cholesterol and they are children of PPAR-α, namely candidate regulatees of PPAR-α, in our estimated network. As for LDLR, it has been reported the relationship with PPAR-α. Moreover, several genes related to cholesterol metabolism are children of PPAR-α in our network. We also could extract from our network that STAT5B and GLS are children of PPAR-α, for which their regulation relationships with PPAR-α have been reported. Therefore, it is not surprising that our network shows that many direct and indirect relationships involving known PPAR-α regulatees are triggered in endothelial cells by fenofibrate treatment. In the node upstream of PPAR-α, PPAR-α and RXR-α, which form a heterodimer, share a parent. Using the method of the present invention, we could generate the fenofibrate-related gene network and thereby estimate that PPAR-α is the one of the key molecules of fenofibrate regulations without prior biological knowledge.

From the point of view of pharmacogenomics, it is very important to know druggable gene networks. Our gene networks have the potential to predict the mechanism-of-action of a chemical compound, discover more effective drug targets, and predict side effects arising from exposure to a given drug. The present invention provides a computational method for discovering gene networks relating to a chemical compound. We used gene knock-down microarray data and time-course response microarray data for this purpose and combine multiple information obtained from observational data in order to estimate accurate gene networks under a Bayesian statistics framework. We illustrated the entire process of the method using an actual example of gene network inference in human endothelial cells. Using fenofibrate time-course data and data from gene knock-downs in human endothelial cells, we successfully estimated a gene network related to the drug fenofibrate, which is a known agonist of PPAR-α. In the estimated gene network, PPAR-α has many direct and indirect regulatees including lipid metabolism related genes and this result indicates PPAR-α works as a trigger of the estimated fenofibrate-related network. There are many known relationships in the candidate regulatees of PPAR-α and we could find the relationship between PPAR-α and RXR-\alpha in the estimated network. Peroxisome proliferator-activated receptors (PPARs) are ligand-activated transcription factors expressed by endothelial cells and several other cell types. They are activated by ligands such as naturally occurring fatty acids and synthetic fibrates. Once activated, they heterodimerize with the retinoid-X-receptor (RXR) to activate the transcription of target genes. Many of these genes encode proteins that control carbohydrate and glucose metabolism and down-regulate inflammatory responses.

### Application to the Study of Human Endothelial Cell Apoptosis

The present invention was also applied in a study of the human endothelial cell (EC) apoptosis process.

### Example 4

### Apoptosis Time Course Gene Array Data

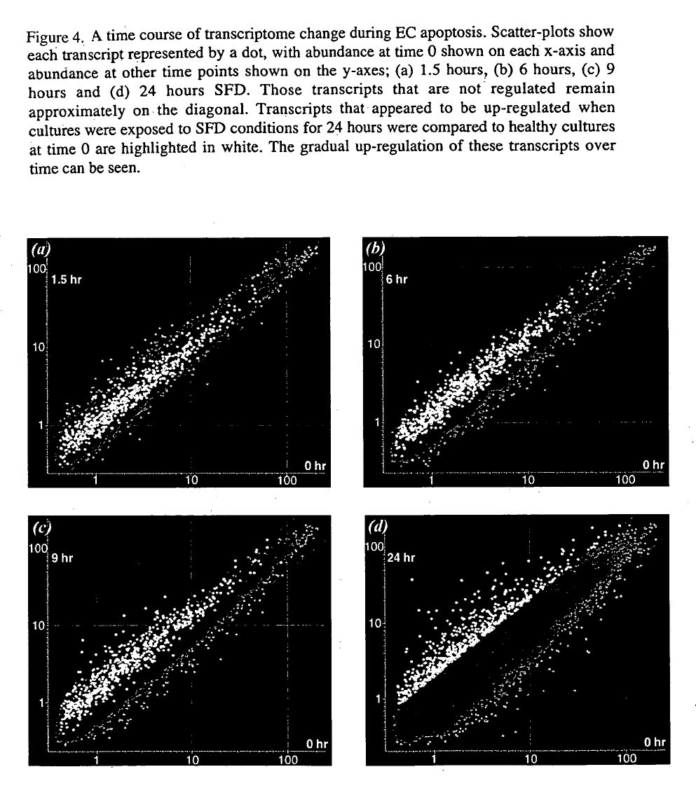

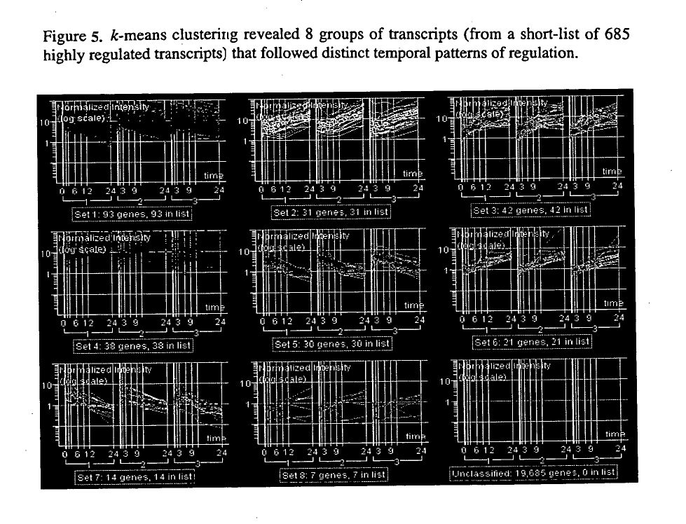

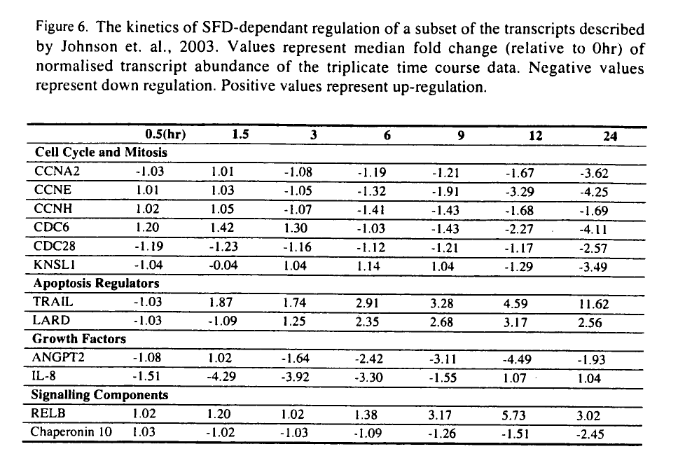

To understand the kinetics of transcriptome change during EC apoptosis, we performed a time course experiment. HUVEC (a pooled culture from 10 donors) were exposed to SFD conditions identical to those used in the study described above. RNA was prepared from the cultures before the induction of apoptosis (time 0) and after 0.5, 1.5, 3, 6, 9, 12 and 24 hours, hybridised to CodeLink Human Uniset 20K gene arrays. This experiment was repeated independently three times. The regulation of transcripts during EC apoptosis can be visualized in the scatter plots shown in FIG. 4A-D. We then selected a subset of 276 transcripts which were consistently regulated over the timecourse of EC apoptosis for further analysis. To do this we excluded all transcripts from our analysis that were not regulated by Z≧1.5 σ at ≧3 adjacent time points in all three experimental replicates (see methods). From these 276 transcripts, k-means clustering was used to select 8 groups of transcripts (in addition to an unclassified group) with similar time course profiles (FIG. 5). From these profiles and from the scatter-plots shown in FIG. 5a-d, it can be seen that a number of transcripts start to be regulated form 1.5 hours and that in general the rate of change appears to low after 12 hours. When we plotted the individual transcripts identified in the previous study, we noted that in general, the transcripts encoding growth factors (such as Ang-2 and IL-8) were among the earliest transcripts to be regulated, while transcripts associated with the cell cycle (such as cyclins A2, H, and E, CDC6, CDC28 and kinesin-like spindle protein) were regulated later (FIG. 6). The regulation of many of these transcripts following 28 hours SFD has been validated by our previous Affymetrix study. These data suggest that some functional classes follow common patterns of regulation during the SFD-induced apoptosis of EC cultures. More sophisticated analysis (see Example 5) suggests common upstream regulators of these transcripts.

### Example 5

### Combination of Apoptosis Time Course Gene Array Data and Data from Gene Disruptant Experiments to Generate a Gene Network

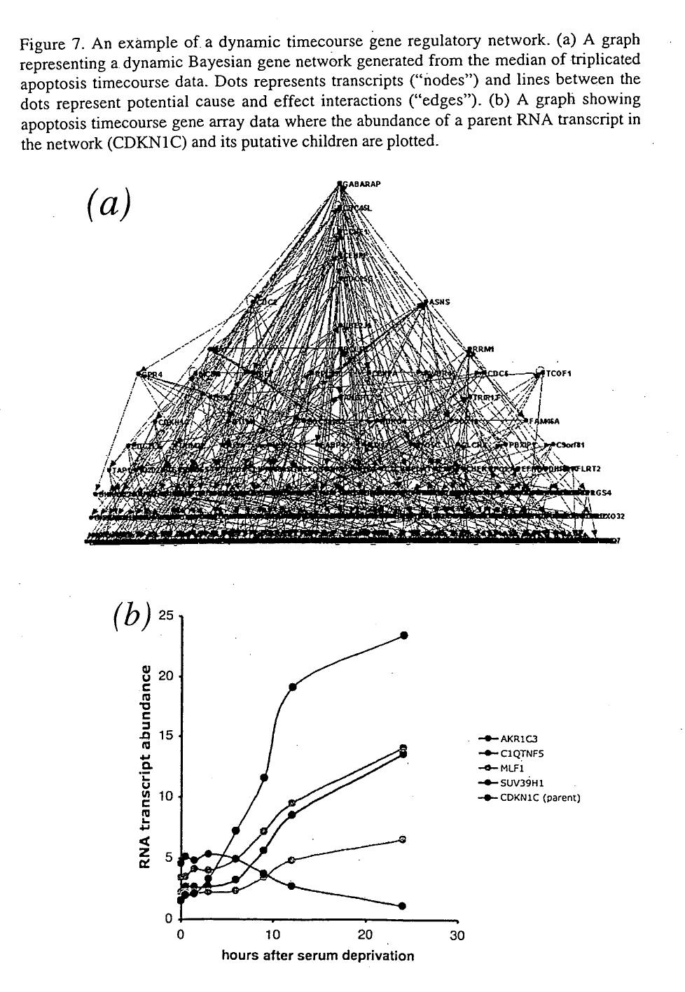

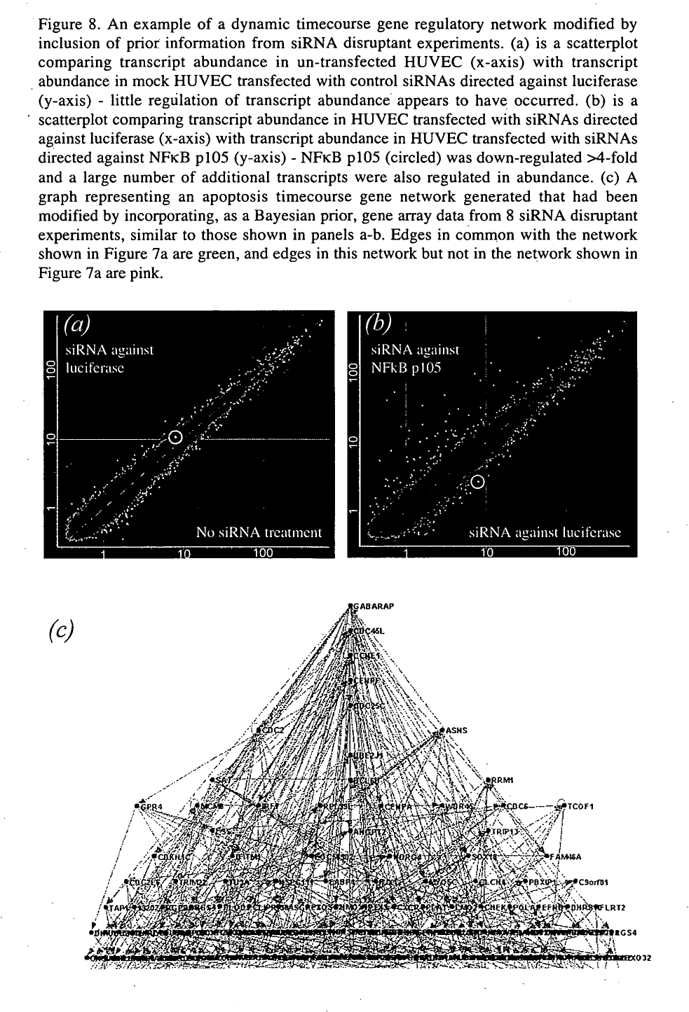

We generated a gene network (FIG. 8C) from the apoptosis time course gene array data described above. This network differs from the one shown in FIG. 7A, which was generated based on the median of the HUVEC apoptosis time course gene array data of Example 4 using the dynamic Bayesian network inference method (Kim et al. 2003), in that this network incorporated (as a “Bayesian prior”) new gene array data from eight disruptant experiments in the manner provided by the present invention. In these eight disruptant experiments, specific RNAs related to cell cycle control (CDC45L, CCNE1, CENPA, CENPF, CDC2, CDC25C, MCM6 and CDC6) were reduced in abundance by >65% in HUVEC using siRNA pools. Gene array analysis showed that these siRNA treatments caused large numbers of transcripts to be regulated (presumably as a consequence of the targeted RNA down-regulation, or possibly in some cases also as a consequence of unexpected off-target siRNA effects). An example of the effects of siRNA treatment on the HUVEC transcriptome is shown in FIG. 8A-B. The putative time course gene network modified by incorporation of this disruptant information as a Bayesian prior is shown in FIG. 8C.

Of the 488 edges contained in the modified gene network shown in FIG. 8C, 338 are shared with the unmodified gene network shown in FIG. 7A. 94 of the 150 edges found in the modified but not the unmodified networks have as parents one of the eight RNAs that were targeted in the siRNA disruptant experiments. These particular edges appear to have inherited cause and effect information from the disruptant gene array data, since they all correctly predict the effects on children of disrupting parents by siRNA treatment. Therefore, the inclusion of disruptant data as a Bayesian prior helps enhance the ability of dynamic time course gene networks to predict specific directional relationships between transcripts. Those of skill in the art will also recognize that the present invention can be applied to incorporate data from biological database annotations and proteomics experiments and thereby further enhance the predictive power of the gene network generated.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims. All publications, patents, and patent applications cited herein are hereby incorporated by reference in their entirety for all purposes.
Akutsu, T., Kuhara, S., Maruyama, O. and Miyano, S. 1998 A System for Identifying Genetic Networks from Gene Expression Patterns Produced by Gene Disruptions and Overexpressions. Genome Inform Ser Workshop Genome Inform 9, 151-160.
Chen, T., He, H. L. and Church, G. M. 1999 Modeling gene expression with differential equations. Pac Symp Biocomput, 29-40.
de Hoon, M. J., Imoto, S., Kobayashi, K., Ogasawara, N. and Miyano, S. 2003 Inferring gene regulatory networks from time-ordered gene expression data of Bacillus subtilis using differential equations. Pac Symp Biocomput, 17-28.
Friedman, N., Linial, M., Nachman, I. and Pe'er, D. 2000 Using Bayesian networks to analyze expression data. J Comput Biol 7, 601-20.
Imoto, S., Goto, T. and Miyano, S. 2002 Estimation of genetic networks and functional structures between genes by using Bayesian networks and nonparametric regression. Pac Symp Biocomput, 175-86.
Imoto, S., Tamada, Y., Araki, H., Yasuda, K., Print, C., Charnock-Jones, D., Sanders D, Savoie, C., Tashiro, K., Kuhara, S. and Miyano, S. 2006 Computational strategy for discovering druggable gene networks from genome-wide RNA expression profiles. Pacific Symposium on Biocomputing 11, 559-571.
Johnson, N. A., Sengupta, S., Saidi, S. A., Lessan, K., Charnock-Jones, S. D., Scott, L., Stephens, R., Freeman, T. C., Tom, B. D., Harris, M., Denyer, G., Sundaram, M., Sasisekharan, R., Smith, S. K. and Print, C. G. 2004 Endothelial cells preparing to die by apoptosis initiate a program of transcriptome and glycome regulation. Faseb J 18, 188-90.
Rangel, C., Angus, J., Ghahramani, Z., Lioumi, M., Sotheran, E., Gaiba, A., Wild, D. L. and Falciani, F. 2004 Modeling T-cell activation using gene expression profiling and state-space models. Bioinformatics 20, 1361-72.
Schoenfeld, J., Lessan, K., Johnson, N. A., Charnock-Jones, D. S., Evans, A., Vourvouhaki, E., Scott, L., Stephens, R., Freeman, T. C., Saidi, S. A., Tom, B., Weston, G. C., Rogers, P., Smith, S. K. and Print, C. G. 2004 Bioinformatic analysis of primary endothelial cell gene array data illustrated by the analysis of transcriptome changes in endothelial cells exposed to VEGF-A and PIGF. Angiogenesis 7, 143-56.
Shmulevich, I., Dougherty, E. R., Kim, S. and Zhang, W. 2002 Probabilistic Boolean Networks: a rule-based uncertainty model for gene regulatory networks. Bioinformatics 18, 261-74.
T. Akutsu et al., Pac. Symp. Biocomput., 4:17-28, 1999.
K. Basso et al., Nat. Genet., 37:382-390, 2005.
A. Bernard and A. J. Hartemink, Pac. Symp. Biocomput., 10:459-470, 2005
A. Cabrero et al., Curr. Drug Targets Inflamm. Allergy, 1:243-248, 2002.
T. Chen et al., Pac. Symp. Biocomput., 4:29-40, 1999.
D. di Bernardo et al., Nat. Genet., 37:382-390, 2005.
N. Friedman et al., J. Comp. Biol., 7:601-620, 2000.
K. Goya et al., Arterioscler. Thromb. Vasc. Biol., 24:658-663, 2004.
A. J. Hartemink et al., Pac. Symp. Biocomput., 7:437-449, 2002.
K. Hayashida et al., Biochem. Biophys. Res. Commun., 323:1116-1123, 2004.
D. Heckerman et al., Machine Learning, 20:197-243, 1995.
S. Imoto et al., Pac. Symp. Biocomput., 7:175-186, 2002.
S. Imoto et al., J. Bioinform. Comp. Biol., 2:77-98, 2004.
S. Imoto et al., J. Bioinform. Comp. Biol., 1:459-474, 2003.
K. K. Islam et al. Biochim. Biophys. Acta., 1734:259-268, 2005.
S. Kersten et al., FASEB J., 15:1971-1978, 2001.
S. Kim et al., Biosystems, 75:57-65, 2004.
T. I. Lee et al., Science, 298:799-804, 2002.
M. J. Marton et al., Nat. Med., 4:1293-1301, 1998.
C. J. Savoie et al., DNA Res., 10:19-25, 2003.
J. M. Shipley and D. J. Waxman, Mol. Pharmacol., 64:355-364, 2003.
Y. Tamada et al., Genome Informatics, 16:182-191, 2005.
E. P. van Someren et al., Pharmacogenomics, 3:507-525, 2002.

What is claimed is:

1. A method of constructing a gene network, comprising:
converting one or more types of biological data into a representation of values;
using at least one of the representation of values from the one or more types of biological data as a Bayesian prior probability in a Bayesian computational model to construct the gene network.

2. The method of claim 1, wherein the one or more types of biological data comprises gene expression data.

3. The method of claim 2, wherein the gene expression data is obtained by transcript detection.

4. The method of claim 1, comprising at least two types of gene expression data.

5. The method of claim 4, wherein at least one type of the at least two types of gene expression data is time-course gene expression data.

6. The method of claim 4, wherein at least one type of the at least two types of gene expression data is gene knockdown expression data.

7. The method of claim 4, wherein said two types of gene expression data are time-course gene expression data and gene knockdown expression data.

8. The method of claim 1, wherein the representation of values is a matrix representation.

9. The method of claim 1, wherein the values are discrete or continuous values.

10. The method of claim 7, wherein the converting step comprises:
creating a gene expression matrix from the time-course gene expression data for a first set of genes, said data including expression results based on time course of expression of each gene in the first set, quantifying an average effect and a measure of variability of each time point on each other of said genes in the first set;
generating network relationships between said genes in the first set;
providing a Bayesian computation model based on said time course expression data as a first Bayesian prior probability, wherein said Bayesian model comprises minimizing a BNRC_{dynamic} criterion;
creating a gene expression matrix from the gene knock-down expression data of a second set of genes, said data including expression results based on disruption of each gene from a third set of genes, quantifying an average effect and a measure of variability of disruption of each of the genes in the third set on expression of each of the genes in the second set;
generating network relationships between genes in the second set and genes in the third set; and
providing a matrix representation of said network relationships between genes in the second set and genes in the third set as a second Bayesian prior probability.

11. The method of claim 10, wherein said measure of variability is variance.

12. The method of claim 10, wherein said step of minimizing a BNRC_{dynamic} criterion comprises using a non-linear curve fitting method selected from the group consisting of polynomial bases, Fourier series, wavelet bases, regression spline bases and B-splines.

13. The method of claim 12, wherein the non-linear curve fitting method is a non-parametric method.

14. The method of claim 13, wherein said non-parametric method for minimizing a BNRC_{dynamic} criterion includes using heterogeneous error variances.

15. The method of claim 10, wherein a reliability of edge in the Bayesian computational model is determined using a bootstrap method.

16. The method of claim 15, wherein said bootstrap method comprises the steps of:
a) providing a bootstrap gene expression matrix by randomly sampling a number of times, with replacement, from the time course gene expression data for the first set;
b) estimating the gene network based on the bootstrap gene expression matrix;
c) repeating steps a) and b) B times, thereby producing B gene networks; and
d) calculating the reliability of edge from said B gene networks.

17. The method of claim 10, further comprising combining a gene knockdown expression data matrix with the first and second Bayesian prior probabilities to construct the gene network.

18. A computer program product for use in conjunction with a computer system, the computer program product comprising a computer readable storage medium and a computer program mechanism embedded therein, the computer program mechanism comprising a construction module for constructing a gene network, comprising:
(a) instructions for converting one or more types of biological data respectively into a representation of values;
(b) instructions for using each representation of values as a Bayesian prior probability in a Bayesian computational model to construct the gene network.

19. A computer readable memory, being a storage medium and comprising:
a computer program including embedded therein instructions executable by a processor, wherein the processor when executing the instructions performs a plurality of steps, including:
converting one or more types of biological data respectively into a representation of values;
using each representation of values as a Bayesian prior probability in a Bayesian computational model to construct the gene network.

20. A database comprising a gene network model constructed by the method of claim 1.

21. A method of identifying a gene network affected by an agent, comprising:
providing time course gene expression data for a first set of genes generated from exposure to an agent;
providing gene knockdown expression data for a second set of genes;
identifying a gene network affected by the agent based on a combination of time course gene expression data and gene knockdown expression data, wherein at least one of the time course expression data and gene knockdown expression data is used as a Bayesian prior in a Bayesian computational model.

22. A method of identifying a target gene in a system containing a gene network, comprising the steps of claim 1, wherein a parent gene in the gene network constructed by the method of claim 1 is selected to be the target gene.
